(19) United States
(12) Patent Application Publication
(10) Pub. No.: US 2007/0032373 A1
(43) Pub. Date: Feb. 8, 2007

(54) Method of regenerating deteriorated catalyst

(75) Inventors: Nobuo Matsumoto, Osaka (JP); Tetsuo Kodama, Osaka-shi (JP); Atsushi Fukuju, Hiratsuka-shi (JP); Masayoshi Ichiki, Sakai-shi (JP); Kazuhiro Yano, Osaka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: HITACHI ZOSEN CORPORATION, Osaka-shi (JP)

(21) Appl. No.: 10/572,311

(22) PCT Filed: Sep. 21, 2004
(86) PCT No.: PCT/JP04/14133

§ 371 Date: Mar. 17, 2006

(30) Foreign Application Priority Data
Sep. 18, 2003 (JP) 2003-325676

(51) Int. Cl. B01J 38/00

(52) U.S. Cl. 502/20; 502/26; 502/27

(57) ABSTRACT

The invention is to provide a method for regenerating a deteriorated denitration catalyst by an easy and simple procedure. A catalyst that is used for reduction removal of NOₓ contained in a exhaust gas by using ammonia as a reducing agent and has been deteriorated in activity through long term use is washed with an acid aqueous solution having pH of 4 or less, and preferably 2 or less, containing vanadium and/or tungsten. The washing operation dissolves away mainly an alkali metal, an alkaline earth metal, arsenic and sulfur, which are deteriorating components, and vanadium and tungsten having been deteriorated in activity, and simultaneously vanadium and/or tungsten as an active component is deposited thereon. Examples of the alkali metal include potassium and sodium, and examples of the alkaline earth metal include calcium.

### TECHNICAL FIELD

The present invention relates to a method for regenerating a denitration catalyst which catalytically reduces a nitrogen oxide in a exhaust gas by using ammonia as a reducing agent and has been deteriorated. The deteriorated denitration catalysts include those used in a dirty exhaust gas, such as a coal-burning exhaust gas, and those used in a clean exhaust gas, such as a gas turbine exhaust gas.

### BACKGROUND ART

Various proposals have been conventionally made for a regenerating method of a deteriorated denitration catalyst (see Japanese Patent No. 2,994,769, JP-A-11-057410, JP-A-2000-037634, JP-A-2000-037635, JP-A-10-235209, JP-A-10-066875, JP-A-07-222924, JP-A-06-099164, JP-A-10-337483, JP-A-10-156193, JP-A-10-156192, JP-A-2000-107612 and JP-A-2000-102737). These methods include a method of washing a deteriorated catalyst with an alkali aqueous solution and re-depositing its active component thereon to regenerate it, a method of washing a deteriorated catalyst with an acid aqueous solution and re-depositing its active component thereon to regenerate it, and a method of washing a deteriorated catalyst with an alkali aqueous solution and then with an acid aqueous solution, and then re-depositing its active component thereon to regenerate it.

### DISCLOSURE OF THE INVENTION

Upon using a denitration catalyst for treating a coal-burning exhaust gas, a gas turbine exhaust gas and the like for a long period of time, deteriorating components, such as calcium, potassium, sodium, arsenic and sulfur, contained in the exhaust gas and ash cause deterioration in activity, and thermal aggregation of vanadium and tungsten, which are active components, causes deterioration in activity. According to any of the aforementioned regenerating methods, i.e., the method of washing a deteriorated catalyst with an alkali aqueous solution and re-depositing its active component thereon to regenerate it, the method of washing a deteriorated catalyst with an acid aqueous solution and re-depositing its active component thereon to regenerate it, and the method of washing a deteriorated catalyst with an alkali aqueous solution and then with an acid aqueous solution, and then re-depositing its active component thereon to regenerate it, the active component must be re-deposited thereon since the active component is dissolved by washing, and it is necessary that the washing operation and the re-depositing operation of the active component are carried out separately. Therefore, there are such problems that the treating steps and the management of solutions become complicated, and the amounts of waste solutions are increased to rise the cost.

An object of the invention is to provide, in view of the aforementioned problems, a method of regenerating a deteriorated denitration catalyst by an easy and simple procedure.

The inventors have noted the following points for solving the aforementioned problems.

(1) A regenerating method only by acid or alkali washing causes dissolution of a catalytic component to fail to restore the performance completely, and thus the active component must be re-deposited.

(2) An aqueous solution containing vanadium and/or tungsten is stable over a wide range of pH.

Upon noting these points, such an easy and simple regenerating method has been completed that a deteriorated catalyst is washed with an acid aqueous solution containing vanadium and/or tungsten, or washed with an alkali aqueous solution containing vanadium and/or tungsten, whereby deteriorating components accumulated in the catalyst and vanadium and tungsten having been deteriorated in activity are dissolved into the solution, and simultaneously vanadium and/or tungsten as an active component can be re-deposited thereon. The regenerating method of washing with an acid aqueous solution containing vanadium and/or tungsten is more effective when applied to a catalyst containing a deteriorating factor that is mainly alkali. The regenerating method of washing with an alkali aqueous solution containing vanadium and/or tungsten is more effective when applied to a catalyst containing a deteriorating factor that is mainly arsenic.

A first aspect of the present invention is a method for regenerating a deteriorated catalyst characterized by comprising a step of washing a catalyst that is used for reduction removal of NOₓ contained in a exhaust gas by using ammonia as a reducing agent and has been deteriorated in activity through long term use with an acid aqueous solution having pH of 4 or less, and preferably 2 or less, containing vanadium and/or tungsten, so as to dissolve away mainly an alkali metal, an alkaline earth metal, arsenic and sulfur, which are deteriorating components, and vanadium and tungsten having been deteriorated in activity, and simultaneously to deposit vanadium and/or tungsten as an active component thereon. Examples of the alkali metal include potassium and sodium, and examples of the alkaline earth metal include calcium.

In the first aspect of the invention, the acid is preferably nitric acid, hydrochloric acid and/or sulfuric acid.

A second aspect of the invention is a method for regenerating a deteriorated catalyst characterized by comprising a step of washing a catalyst that is used for reduction removal of NOₓ contained in a exhaust gas by using ammonia as a reducing agent and has been deteriorated in activity through long term use with an alkali aqueous solution having pH of 8 or more, and preferably 10 or more, containing vanadium and/or tungsten, so as to dissolve away mainly an alkali metal, arsenic and sulfur, which are deteriorating components, and vanadium and tungsten having been deteriorated in activity, and simultaneously to deposit vanadium and/or tungsten as an active component thereon. Examples of the alkali metal include potassium and sodium.

In the second aspect of the invention, the alkali aqueous solution is preferably aqueous ammonia.

According to the invention, a deteriorated denitration catalyst can be regenerated by an immersion operation only once, which is an easy and simple procedure.

### BRIEF DESCRIPTION OF THE DRAWINGS

FIG. 1 is a graph showing performances of regenerated catalysts of Example 1 and Comparative Example 1 before and after regeneration.

FIG. 2 is a graph showing performances of regenerated catalysts of Example 2 and Comparative Example 2 before and after regeneration.

### BEST MODE FOR CARRYING OUT THE INVENTION

Examples of the invention and comparative examples for comparing therewith are shown below for specifically describing the invention.

### EXAMPLE 1

(1) Denitration Performance

The performance of a catalyst is defined by K/K₀, in which assuming that the denitration reaction is a first-order reaction of NOₓ, K represents the reaction rate constant where the ratio NOₓ/NH₃=1.0 (K=−(AV)ln(1−x)), wherein AV represents an amount of a exhaust gas per geometric surface area of the catalyst, and x represents the denitration rate, and K₀ represents the initial reaction rate constant having not been subjected to deterioration. Therefore, K/K₀=1 in the initial state.

(2) Regeneration of Deteriorated Denitration Catalyst

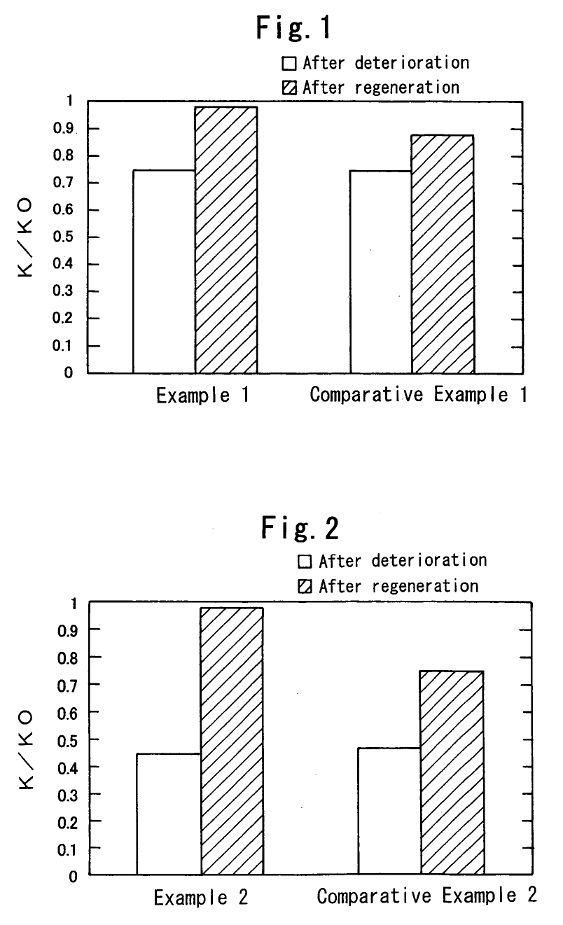

A catalyst having been deteriorated in performance by using denitration of a coal-burning exhaust gas for a long period of time was measured for activity. An aqueous solution (pH 1.2) was prepared by adding ammonium metavanadate (NH₄VO₃) to a nitric acid aqueous solution to a concentration of 0.03 mol/L, in which the catalyst having been deteriorated in activity was immersed for 5 hours. After immersion, it was calcined at 250° C. for 1 hour, and measured for restoration of performance. The results are shown in FIG. 1. The performance was restored to approximately initial performance by applying the treating operation only once.

### EXAMPLE 2

Regeneration of Arsenic-Deteriorated Catalyst

A denitration catalyst was exposed to air containing arsenic oxide vapor in an amount of about 25 ppm in terms of As at 350° C. for 4 hours for deterioration of performance to prepare a simulated arsenic-deteriorated catalyst. An aqueous solution (pH 10.2) was prepared by adding ammonium metavanadate (NH₄VO₃) to an NH₃ aqueous solution to a concentration of 0.03 mol/L and adding WO₃ thereto to a concentration of 0.5 mol/L, in which the arsenic-deteriorated catalyst was immersed for 5 hours. After immersion, it was calcined at 400° C. for 1 hour, and measured for restoration of performance. The results are shown in FIG. 2. The performance was restored to approximately initial performance by applying the treating operation only once.

### COMPARATIVE EXAMPLE 1

Regeneration of Deteriorated Denitration Catalyst

The same operations as in the regeneration process of the deteriorated denitration catalyst (2) in Example 1 were repeated except that the immersion was carried out by using a nitric acid aqueous solution (pH 1.2) containing no ammonium metavanadate. The results are shown in FIG. 1. By the treating only with a nitric acid aqueous solution (pH 1.2), the active component was dissolved upon treating, and thus the activity was not restored to the initial performance.

### COMPARATIVE EXAMPLE 2

Regeneration of Deteriorated Denitration Catalyst

The same operations as in Example 2 were repeated except that the immersion was carried out by using an NH₃ aqueous solution (pH 10.2) containing no ammonium metavanadate or WO₃. The results are shown in FIG. 2. By the treating only with an NH₃ aqueous solution (pH 10.2), the active component was dissolved upon treating, and thus the performance was not restored to the initial performance.

### INDUSTRIAL APPLICABILITY

The invention provides a method for regenerating a denitration catalyst that catalytically reduces a nitrogen oxide in a exhaust gas by using ammonia as a reducing agent and has been deteriorated. According to the invention, the deteriorated denitration catalyst can be regenerated by an immersion operation only once, which is an easy and simple procedure.

1. A method for regenerating a deteriorated catalyst characterized by comprising a step of washing a catalyst that is used for reduction removal of NOₓ contained in a exhaust gas by using ammonia as a reducing agent and has been deteriorated in activity through long term use with an acid aqueous solution having pH of 4 or less containing vanadium and/or tungsten, so as to dissolve away mainly an alkali metal, an alkaline earth metal, arsenic and sulfur, which are deteriorating components, and vanadium and tungsten having been deteriorated in activity, and simultaneously to deposit vanadium and/or tungsten as an active component thereon.

2. The method for regenerating a deteriorated catalyst as claimed in claim 1, characterized in that nitric acid, hydrochloric acid and/or sulfuric acid is used as the acid.

3. A method for regenerating a deteriorated catalyst characterized by comprising a step of washing a catalyst that is used for reduction removal of NOₓ contained in a exhaust gas by using ammonia as a reducing agent and has been deteriorated in activity through long term use with an alkali aqueous solution having pH of 8 or more containing vanadium and/or tungsten, so as to dissolve away mainly an alkali metal, arsenic and sulfur, which are deteriorating components, and vanadium and tungsten having been deteriorated in activity, and simultaneously to deposit vanadium and/or tungsten as an active component thereon.

4. The method for regenerating a deteriorated catalyst as claimed in claim 3, characterized in that aqueous ammonia is used as the alkali aqueous solution.
